(19) United States
(12) Patent Application Publication
(10) Pub. No.: US 2024/0069322 A1
(43) Pub. Date: Feb. 29, 2024

(54) METHODS AND SYSTEMS TO COMPENSATE FOR SUBSTRATE THICKNESS ERROR

(71) Applicant: Molecular Devices, LLC, San Jose, CA (US)

(72) Inventor: Matthew Chan, Palo Alto, CA (US)

(73) Assignee: Molecular Devices, LLC, San Jose, CA (US)

(21) Appl. No.: 18/259,817

(22) PCT Filed: Jan. 5, 2022
(86) PCT No.: PCT/US2022/011324

§ 371 Date: Jun. 29, 2023

Related U.S. Application Data
(60) Provisional application No. 63/134,033, filed on Jan. 5, 2021.

(51) Int. Cl. G02B 21/36; G02B 21/06; G02B 21/24

(52) U.S. Cl. CPC G02B 21/367; G02B 21/06; G02B 21/242

(57) ABSTRACT

A well tray includes a base including an upper surface, a lower surface and at least one edge surface connecting the upper surface to the lower surface. The at least one edge surface defines a slot. The slot is in communication with a magnet receiver at least partially defined between the upper surface and the lower surface. The magnet receiver is configured to slidably receive a removable magnet. The tray includes a plurality of wells disposed on an upper surface of the base.

### CROSS-REFERENCE TO RELATED APPLICATION

This application is being filed on Jan. 5, 2022, as a PCT International Patent Application and claims priority to and the benefit of U.S. Provisional Application Ser. No. 63/134,033, filed on Jan. 5, 2021, the disclosure of which is hereby incorporated by reference herein in its entirety.

### INTRODUCTION

Technicians often use optical microscopy imaging systems during high-content screenings (HCS) to obtain images of microscopy samples. A sample holder—e.g., a microtiter plate, slide, dish, etc.—may support the microscopy samples during the screening process. Automated microscopy imaging systems may include an objective coupled to an electronic imaging device such as a charge-coupled device (CCD) or a complementary metal-oxide-semiconductor (CMOS) chip to produce the images of the microscopy samples. The position of the objective relative to the sample holder may be adjusted to bring the microscopy samples into focus on the imaging device.

To increase the efficiency of imaging, multiple imaging devices may be used to image a plurality of wells in parallel (i.e., simultaneously). However, the time required to focus the objective of each of the multiple imaging devices may eliminate any efficiencies that may be gained from parallel imaging. Further, the focusing each objective individually may also increase the complexity of the imaging system. In various imaging configurations, such as inverted or epi-fluorescent microscope, samples are viewed through glass cover slips, glass slides and bottom plate of sample holders (e.g., Petri dishes, micro titer plates). However, variations in the thickness and/or curvature of the base of the sample holder may hamper accurate focus over a range of measurement locations. As a result, the focal position of the objective lens needs to be corrected at each measurement location having the thickness and/or curvature variations in order to obtain respective in-focus images for all measurement locations. Because high content screenings may image hundreds or thousands of measurement samples, some microscopy imaging systems may be configured to automatically perform focus maintenance at each measurement location.

Even with auto-focus equipment, other errors in the optical system can hamper accurate focus over a range of measurement locations. Generally, a large magnification objective is designed in such a way as to obtain a clear image when observing a fixed specimen using a piece of cover glass whose thickness and refractive index is predetermined. When observing using a piece of cover glass whose thickness and refractive index may deviate from a standard, aberrations occur which can obscure a clear image. A lens with a larger numerical aperture can visualize finer details than a lens with a smaller numerical aperture. Furthermore, lenses with larger numerical apertures collect more light and will generally provide a brighter image, but at the expense of a shallower depth of field. However, the larger the numerical aperture of an objective lens is, the more pronounced the distortion in an image (such as spherical aberration) will be.

Typically, commercially available objective lenses will be designed for a specific thickness of such sample holders or covers. When a sample holder with different thickness of bottom plate is used, the deviation from specified thickness can cause significant degradation of an image quality due to spherical aberrations introduced by the sample holder. A correction collar may be provided which allows for compensation of the spherical aberration. In general laboratory practice, a technician using a microscope adjusts a spherical aberration correction setting by: (1) manual rotation of the collar, while observing a live image on the computer screen, and/or (2) setting the collar to a known sample holder thickness using a scale placed on the microscope objective.

Therefore, in some objective imaging systems, a part of a lens system constituting the objective can be moved relative to the optic axis. Such an objective is known in the art as an objective with a correction collar. When using a correction collar, a clear image may be obtained despite variations or deviations in the thickness and/or curvature of the sample holder. However, it is not straightforward to correct for aberrations with a correction collar, and usually only a skilled technician can find a position where the image is the clearest.

### SUMMARY

To address a number of problems generally described herein, in whole or in part, and/or other problems that may have been observed by persons skilled in the art, the present disclosure provides methods, processes, systems, apparatus, instruments, and/or devices, as described by way of example in implementations set forth below.

According to an embodiment, there is provided an optical imaging system comprising: a sample stage configured to hold a sample to be imaged on a top surface of a sample coverslip; an objective lens disposed underneath the sample stage and configured to image the sample on the top surface of the sample coverslip; an optical detector configured to capture at least a sample image of the sample on the sample coverslip; and a processor programmed to retrieve reference image data from a reference image captured from a calibration coverslip, retrieve test image data from a test image captured from light reflected from a top surface of the sample coverslip at a focal plane of the objective lens, process the reference image data and the test image data to produce (via a deconvolution of the test image data) a calculated point spread function associated with the objective lens and other optical components in use, and deconvolve the sample image using the calculated point spread function to thereby reduce artifacts from the sample image.

According to another embodiment, there is provided an optical imaging system comprising: an objective lens; a sample stage configured to position a top surface of a) a sample coverslip for holding a sample or b) a calibration coverslip at a focal plane of the objective lens; an optical detector configured to capture at least a) a sample image of the sample on the sample coverslip, b) a reference image from light reflected back through the calibration coverslip from the focal plane of the objective lens, and c) a test image from light reflected back through the sample coverslip from the focal plane of the objective lens; and a processor programmed to retrieve reference image data from the reference image, retrieve test image data from the test image, deconvolve the test image data using the reference image data as an initial point spread function for the objective lens and the coverslip, through at least one deconvolution of the test image data, produce a deconvolved test image associated with a calculated point spread function for the objective lens and other optical components in use including the sample coverslip, and deconvolve the sample image using the calculated point spread function from the deconvolution of the test image data to thereby reduce artifacts from the sample image.

According to another embodiment, there is provided a computerized method for imaging a sample, comprising: capturing a sample image of the sample using an objective lens disposed underneath a sample coverslip holding the sample; obtaining reference image data obtained from a calibration coverslip, capturing test image data obtained from light reflected from a top surface of the sample coverslip at a focal plane of the objective lens; processing the reference image data and the test image data to produce (via a deconvolution of the test image data) a calculated point spread function associated with the objective lens and other optical components in use; and deconvolving the sample image using the calculated point spread function to thereby reduce artifacts from the sample image.

Other devices, apparatuses, systems, methods, features and advantages of the technology will be or will become apparent to one with skill in the art upon examination of the following figures and detailed description. It is intended that all such additional systems, methods, features and advantages be included within this description, be within the scope of the technology, and be protected by the accompanying claims.

### BRIEF DESCRIPTION OF THE DRAWINGS

The technology can be better understood by referring to the following figures. The components in the figures are not necessarily to scale, emphasis instead being placed upon illustrating the principles of the technology. In the figures, like reference numerals designate corresponding parts throughout the different views.

FIG. 1 is a conventional configuration of a background microscope using a correction collar;

FIG. 2 is a schematic illustration of one embodiment of the optical system of the present technology using a standard reference plate to derive an optimized point spread function associated with the objective lens and other optical components in use including the coverslip;

FIG. 3 is an intensity profile from a single bead taken at an optimized correction collar setting;

FIG. 4 is an intensity profile from the same bead as in FIG. 3 taken at a non-optimized correction collar setting;

FIG. 5 is an intensity profile of a captured image from the same bead as in FIG. 3 taken at a non-optimized correction collar setting and then processed in accordance with the present technology;

FIG. 6A is a depiction of a captured image taken from a 4.0 μm bead under non-optimal imaging conditions;

FIG. 6B is a processed image depiction of the captured image of the bead in FIG. 6A processed in accordance with the present technology;

FIG. 6C is a depiction of a captured image taken from the same 4.0 pim bead of FIG. 6A, but taken here under optimal imaging conditions;

FIG. 6D is a graphical comparison of the intensity profiles of FIGS. 6A, 6B, and 6C;

FIG. 7 is a flowchart illustrating a computerized method of the technology; and

FIG. 8 is a flowchart illustrating another computerized method of the technology.

### DETAILED DESCRIPTION

All numeric values are herein assumed to be modified by the terms “about” or “approximately,” whether or not explicitly indicated, wherein the terms “about” and “approximately” generally refer to a range of numbers that one of skill in the art would consider equivalent to the recited value (i e., having the same function or result). In some instances, the terms “about” and “approximately” may include numbers that are rounded to the nearest significant figure. The recitation of numerical ranges by endpoints includes all numbers within that range (e g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise. In describing the depicted embodiments of the disclosed technology illustrated in the accompanying figures, specific terminology is employed for the sake of clarity and ease of description. However, the disclosure of this patent specification is not intended to be limited to the specific terminology so selected, and it is to be understood that each specific element includes all technical equivalents that operate in a similar manner. It is to be further understood that the various elements and/or features of different illustrative embodiments may be combined with each other and/or substituted for each other wherever possible within the scope of this disclosure and the appended claims.

Various embodiments of the disclosed technology are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the technology or as a limitation on the scope of the disclosed technology, which is defined only by the appended claims and their equivalents. In addition, an illustrated embodiment of the disclosed technology needs not have all the aspects or advantages shown. For example, an aspect or an advantage described in conjunction with a particular embodiment of the disclosed technology is not necessarily limited to that embodiment and can be practiced in any other embodiments even if not so illustrated.

As used in the description below, the terms “imaging,” “image capturing,” “capture of images,” or “detecting an image” shall refer to any process for collecting optical data from an image capturing device. The image may be captured as a digital image for storage, or measuring optical characteristics such as, intensity, color, or other types of data.

As used in the description below, the term “coverslip” shall refer to any sample-holding structure configured to support a container in which a sample may be deposited. In particular, the term “coverslip” may include a tray or similar structure including such sample-holding structures known in the art by terms including “microwells,” “consumable,” “microtiter,” and “microplate”. Alternatively, a “plate” shall be understood to refer to a structure capable of holding a single sample well, or a plurality of sample wells.

As used herein, the term “sample” generally refers to a material known or suspected of containing the analyte. The sample type can be that of cells or tissues, including but not limited to grown cell cultures for experiments of organoids and the like. Samples from cell printing may also be used. In other examples, the sample may be used directly as obtained from the source or following a pretreatment to modify the character of the sample. The sample may be derived from any biological source, such as a physiological fluid, including, blood, interstitial fluid, saliva, ocular lens fluid, cerebral spinal fluid, sweat, urine, milk, ascites fluid, mucous, synovial fluid, peritoneal fluid, vaginal fluid, amniotic fluid or the like. The sample may be pretreated prior to use, such as preparing plasma from blood, diluting viscous fluids, and the like. Methods of pretreatment can involve filtration, precipitation, dilution, distillation, concentration, inactivation of interfering components, chromatography, separation steps, and the addition of reagents. Besides physiological fluids, other liquid samples may be used such as water, food products and the like for the performance of environmental or food production assays. In addition, a solid material known or suspected of containing the analyte may be used as the sample. In some instances it may be beneficial to modify a solid sample to form a liquid medium in order to release the analyte.

As used herein, the term “light” generally refers to electromagnetic radiation, quantizable as photons. As it pertains to the present disclosure, light may propagate at wavelengths ranging from ultraviolet (UV) to infrared (IR). In the present disclosure, the term “light” is not intended to be limited to electromagnetic radiation in the visible range. In the present disclosure, the terms “light,” “photons,” and “radiation” are used interchangeably.

As used herein, “optimized” means improved beyond an original state and does not necessarily mean (unless otherwise stated) that the improvement has been maximized.

As used herein, an “incremental improvement” means that a difference between a starting value and an improvement thereof is within a 30% of the starting value, within 20% of the starting value, within 10% of the starting value, or preferably within 5% of the starting value, and more preferably within 1% of the starting value.

Solutions to some of the issues identified above have been attempted. For example, U.S. Pat. No. 7,825,360 (the entire contents of which are incorporated by reference) addressed certain of the above issues with an optical apparatus including a focusing mechanism for changing a distance between the objective and the sample, an optical thickness detecting unit for detecting the optical thickness of the cover glass, an operating unit for calculating the amount of aberration correction, based on the optical thickness of the cover glass detected by the optical thickness detecting unit, a driver unit for driving a correction collar, based on the amount of aberration correction calculated by the operating unit and an imaging sensor for forming the image of the sample that passes through the objective.

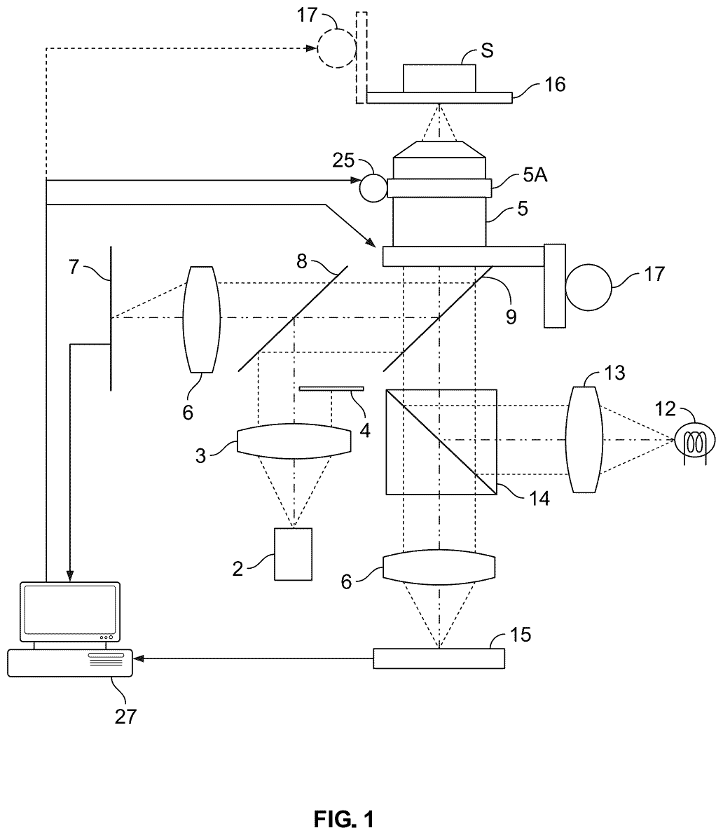

In FIG. 1 (reproduced from the '360 patent), an objective 5 is disposed below a sample to observe the sample S mounted on a stage 16. There is an objective holding member for holding this objective 5. The objective 5 is raised and dropped by a driver unit 17. An excitation light source 12 is provided with an illumination optical system 13 for directing excitation light from light source 12 to objective 5 and specimen S via fluorescent cube 14. The fluorescent cube 14 comprises a dichroic mirror, an excitation filter, and a fluorescent filter in its inside. The observation light of the specimen S that passes through the objective 5 is collected to form an image on an imaging device 15, such as CCD and the like, by a tube lens 6. Alternatively, the specimen S can be illuminated from the top using a transparent illumination light source and a transparent illumination system for collecting the illumination light of the light source on the specimen S, which are not shown in FIG. 1.

Beams emitted from a light source 2 to be used to measure the sample holding member, focusing and the like are reflected on a half-mirror 8 via a collimating lens 3 and on the dichroic mirror 9 disposed between the objective 5 and fluorescent cube 14 to illuminate the specimen S via the objectives 5. As shown in FIG. 1, there is a shielding plate 4 between the collimating lens 3 and the half-mirror 8, which is positioned and almost conjugated with the pupil of the objective 5. The shielding plate 4 shields the half of the beams using the optic axis of the luminous flux of the collimating lens 3 as a boundary to restrict the luminous flux of the light source 2 to half.

The illumination light of the light source 2 returned from the specimen S is collected to form an image on a two-splitting sensor 7 by the tube lens 6 via the objective 5, the dichroic mirror 9 and the half-mirror 8. Since the half of the luminous flux is shielded by the shielding plate 4, the light returned from the specimen S passes through an optical path symmetric with the illumination light using the optic axis as the center and is projected on the two-splitting sensor 7. In this case, the splitting direction of the two-splitting sensor 7 and the splitting direction of the shield ing plate 4 are disposed in relation to each other.

The objective 5 comprises a correction collar 5A and a correction collar driver unit 25 for driving the correction collar 5A. The objective identifying unit, the correction collar driver unit 25, driver unit 17, imaging device 15 and two-splitting sensor 7 are electrically connected to the operation device 27. The objective 5 can be (1) a dry objective with a large numerical aperture in which various aberrations remarkably occur due to the uneven thickness of cover glass (the amount of correction is 0.11 mm to 0.23 mm), (2) an objective for thick glass supposed to use a glass petri dish or the like whose thickness widely differs, in a fairly wide range of 2 mm at maximum or (3) an objective for plastic supposed to use a plastic container whose thickness widely differs, in a fairly wide range of 2 mm at maximum.

As described in one example in the '360 patent, the mechanical thickness of the cover glass as a reference was set to 0.17 mm. If the actual mechanical thickness of the cover glass of a specimen S were 0.13 mm, it was converted to 0.11166 mm in optical thickness by the refractive index (ne=1.5255) of the cover glass. The reference thickness 0.17 mm was converted to 0.08539 mm, respectively. In this case, its optical difference becomes 0.02627 (its mechanical thickness becomes 0.044 mm). In the sub-flow for detecting an optical thickness, the optical thickness (mechanical thickness 0.13 mm) of the actual specimen S was calculated and the amount of drive of the correction collar was calculated on the basis of the difference (mechanical difference 0.04 mm) of the optical thickness against the reference cover glass (S1-7).

Then, as described in the '360 patent, the correction collar was matched with the actual thickness of the cover glass by driving the correction collar to correct aberration caused due to the thickness difference 0.02627 mm (mechanical difference 0.04 mm) as much as possible. At this moment, the space between the sample 18 and the objective 5 deviates from the state where the sample 18 was focused. The calculation of the amount of drive of the correction collar varies depending on the type of an objective and the amount of drive of the correction collar is calculated by a correction collar drive calculation data table or function which is characteristic to an objective. The correction collar drive calculation data table or function which is characteristic to an objective was stored in the operation device 27 and the thickness difference of the correction collar (mechanical difference 0.04 mm) and the amount of drive of the correction collar is calculated by the characteristic correction collar drive calculation data table or function.

As described in the '360 patent, the aberration of the objective 5 was changed by moving the correction collar, and the movement amount was calculated by the aberration correction calculation data table or function which would be characteristic to the objective lens being used. This aberration correction calculation data table or function would be stored in the operation device 27, and the amount of correction of the focus position was calculated by the thickness difference (mechanical difference 0.04 mm) of the correction collar and the aberration correction calculation data table or function.

As another proposed solution, U.S. Pat. No. 10,317,658 (the entire contents of which are incorporated by reference) describes a microscope including: one or more objective lenses each having at least an optical system configured to collect observation light from a specimen, a correction collar provided on each of the one or more objective lenses and configured to move the optical system in a direction of an optical axis of the optical system by rotating around each of the one or more objective lenses to correct aberration; a switching unit to switch positions of the one or more objective lenses; and a focusing unit. Similar to the '360 patent, operation of the correction collar in the '658 patent corrects the aberration (or the spherical aberration) in accordance with the thickness of the slide glass or culture container where the specimen S was placed or stored.

In yet another proposed solution, U.S. Pat. No. 9,383,567 (the entire contents of which are incorporated by reference) describes an objective lens unit provided with a rotatable correction collar. In the '567 patent, the objective lens 41 was provided with an uneven shape along the circumferential direction of the side surface of the objective. The correction collar upon rotation moves the lens group (optical system) in the direction of the optical axis. By this operation of the correction collar in the '567 patent, the aberration (spherical aberration) can be corrected according to the thickness of the slide glass to have the specimen S mounted thereon or the cultivation vessel to have the specimen S housed therein.

In still another proposed solution, U.S. Pat. No. 8,053,711 (the entire contents of which are incorporated by reference) describes a spherical aberration adjustment system which includes a plurality of objective lenses, where at least one of the plurality of objective lenses has a spherical aberration collar. The objective lenses were mounted onto an objective holder, and the objective holder placed one of the plurality of objective lenses in an imaging position. A driving mechanism in the '711 patent was coupled by a mechanical link to one objective lens, and the mechanical link was configured to transmit motion from the driving mechanism to the spherical aberration collar. A control system in the '711 patent was configured to manipulate the driving mechanism to move the spherical aberration collar of one objective lens in the imaging position to a specific spherical aberration adjustment setting. In the '711 patent, the driving mechanism moved the spherical aberration collar of the plurality of objective lenses based on a thickness of a sample holder.

As described in the '711 patent, the spherical aberration correction system operated in one of two modes: protocol-driven and manual. In the protocol-driven mode, the spherical aberration collars of respective objective lenses were adjusted automatically by the spherical aberration correction system based on a protocol in a spherical aberration software program related to a thickness of the sample holder or a resultant thickness of the sample holder and depth of medium of the sample recorded in a protocol. For example, if the specimen holder had a thickness of 0.2 mm then at least one of the spherical aberration collars of the objective lenses was adjusted to a spherical aberration setting of 0.2 mm. In the manual mode of operation, the spherical aberration correction collars of the objective lenses were adjusted to a user-defined setting that is selected via Graphical User Interface (GUI). For example, the user would use the spherical aberration Graphical User Interface (GUI) stored on computer to adjust at least one of the spherical aberration collars to a spherical aberration adjustment setting such as 0.2 mm based on the thickness of the sample holder 121 being 0.2 mm.

Accordingly, while certain types of compensating mechanisms have been proposed in the art for aberration corrections due to variations in substrate thickness variations, these compensating mechanisms often requite complex optics, user-interaction, and translation of optical components in order to provide the compensation. As such, the technology described herein generally relates to improved methods, apparatuses, and systems for compensation for errors in optical microscopy imaging.

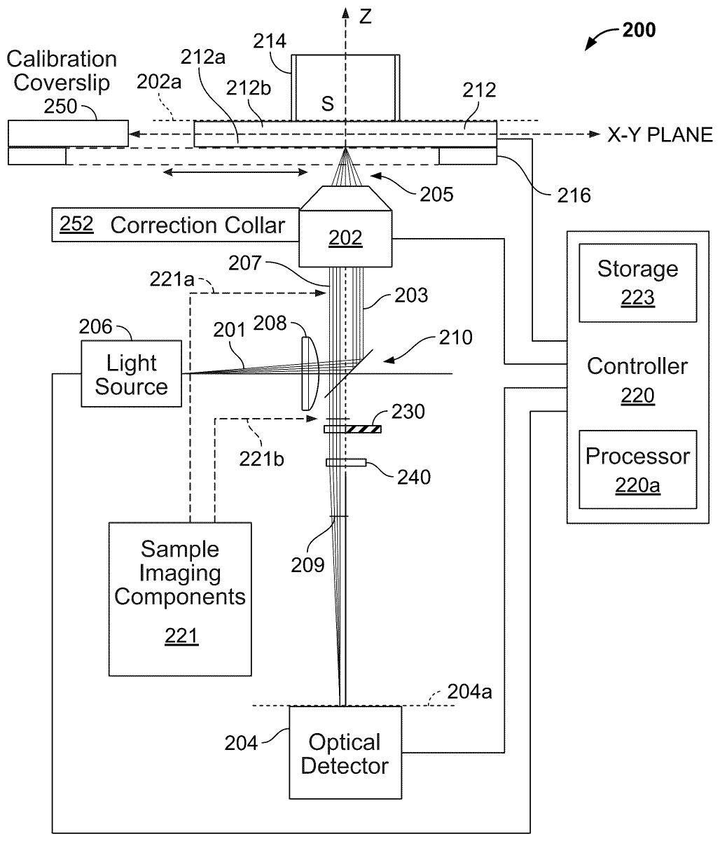

In one embodiment, the present technology is directed to an optical system which is an inverted microscope configuration such as the system shown in FIG. 2. However, the general teachings of the technology are applicable to non-inverted microscope configurations as well (as described below). For an inverted microscope configuration, it is known that image quality degrades due to coverslip thickness mismatch with a microscope objective's intended design. More specifically, because of a thickness of a coverslip (or variations in the thickness of the coverslip at different lateral positions), the obtained images can be distorted by the differences in refractive index between the coverslip material and the sample to be imaged (or the medium holding the sample). As noted in the background, distortions in the image quality due to these differences in refractive index between the coverslip material and the sample are more pronounced for higher numerical aperture (NA) systems, which are often used to collect more light and provide a brighter image and which are often used for higher spatial resolution in both lateral and axial directions. As discussed above, a microscope objective correction collar has conventionally been used to change and possibly correct for spherical aberration in an image due to the presence of the coverslip in the optical path. However, this process is tedious, often involves user interaction, and in some cases does not satisfactorily correct the sample image. Indeed, thickness variation mismatches for the coverslip as compared to the intended design of the microscope objective will often restrict combinations of sample consumables and the objective lenses available, which can result in an unsatisfactory loss of resolution and signal.

The present technology addresses these problems through the following illustrative embodiments which permit images taken from non-optimal conditions to be processed with recovery of sufficient optical quality for image analysis and thereby avoid the necessity of (and time loss associated with) user interaction and correction collar adjustment for every image being captured. Indeed, in one embodiment of the technology, the inventive procedures (described in more detail below where a projected point source of light is used to obtain an acceptable point spread function for deconvolution of sample images) is especially applicable to high numerical aperture systems where the numerical aperture values range from 0.65 to 0.95 or higher, permitting sufficient optical quality for image analysis to be obtained without the necessity of user interaction and correction collar adjustment.

FIG. 2 is an illustration depicting various embodiments of an optical system 200 of the present technology. The system 200 includes an objective lens 202 fora microscope system, an optical detector 204, a light source 206, a first imaging lens 208, a beam splitter 210, a second imaging lens 240, and an aperture 230 (e.g., an aperture off-set from the optical axis Z). The objective lens 202 is configured to perform imaging and/or optical measurements on samples that may be deposited into a sample well 214. Other components of the microscope system include any sample holding structure such as sample stage 216 supporting the sample coverslip 212 with the reference surfaces 212a, 212b. The sample stage 216 (as shown on FIG. 2 by the double arrow below the stage 216) can move either sample coverslip 212 or calibration coverslip 250 into place for imaging.

The system 200 in FIG. 2 can be implemented as a module or a sub-system of the microscope system. Other components that the microscope system 200 uses for imaging samples, such as for example, excitation light source, filters, beam splitters, and sample image capturing device, are represented in FIG. 2 as sample imaging components 221. The sample imaging components 221 may include lenses, filters, or other optical devices, for example, that form optical paths that include the objective lens 202 and the sample coverslip 212 when the microscope system is used to image samples. The microscope system 200 may also use a different light source or a different sample image-capturing device based on the type of imaging or measurement being performed. The optical devices may be inserted below the objective lens in FIG. 2 at 221a above the beam splitter 210, or at 221b above the decentered aperture 230. The sample well 214 in the example shown in FIG. 2A is formed on sample coverslip 212, which provides a bottom reference surface 212a and a top reference surface 212b for the autofocus procedure.

A self-calibration of the best focus position can be performed for a given objective lens 202. Afterwards, the process of focusing that objective lens 202 in subsequent imaging or optical measurements may be performed with minimal further imaging. The calibration of the best focus position may be stored as a reference calibration slope, which may be stored or included with data characterizing the objective lens 202 in a system data storage system 223.

The first imaging lens 208 collimates a light from the light source 206 along optical path 201 and passes the collimated light to the beam splitter 210. The beam splitter 210 reflects a portion of the light toward s the objective lens 202 along optical path 203, and towards the sample coverslip 212 on optical path 205. The sample coverslip 212 reflects the light back to the objective lens 202 and towards the beam splitter 210 on optical path 207. The beam splitter 210 passes a portion of the light along optical path 209 towards the decentered aperture 230. The light that passes through an off-centered opening on the aperture 230 is smaller than the total light beam impinging on the aperture 230. The remaining portion of the aperture 230 occludes the part of the light beam that is not passed through the aperture. The light passing through the aperture 230 is directed to the second imaging lens 240 and to optical detector 204. The decentered aperture 230 operates by sampling a portion of the wavefront from the objective lens 202. The sampled portion of light is focused by the second imaging lens 240 and directed towards the detector but constrained by the decentered aperture as an asymmetric marginal ray. This allows viewing the position of the light and best focus without changing any of the component setup. It should be appreciated that different decentered apertures having different sizes and/or positions may be used to allow for adjustment of sensitivity or for different sizes of the pupil diameter of the objective lens 202. It should also be appreciated that a decentered aperture could also be placed between first imaging lens 208 and beam splitter 210. In this configuration, the detection side does not need the decentered aperture 230. Here, the same principal works: there is an on-axis beam being asymmetrically sampled at the edge of the pupil of objective 202 by a de-centered aperture creating an off-axis beam hitting the smaller imaging lens 240 that responds to defocus of the microscope objective by translating and blurring the image of the projected source when the objective is moving away from best focus. In one embodiment, the decentered aperture is switchable (mechanical or optical) which can increase precision. In one embodiment, the aperture can be moved to permit beam profiling with more light due to the increase in coupling efficiency through the projected source imaging system.

It is noted that the optical paths 201, 203, 205, 207, and 209 shown in FIG. 2 only show light along the optical paths that forms the light beam impinging on optical detector 204. The portion of the light not shown is the portion of the light that is occluded by the occluding portion of aperture 230.

The objective lens 202 is configured to move along the optical paths 203 and 205 on a z-axis (shown in FIG. 2), which is perpendicular to an x-y plane along which the sample coverslip 212 extends. The description below references positions of the objective lens as being on a z-axis, and positions of the reference images, or lateral positions, as being on an x-y plane as a way of providing clarity. It is to be understood that the use of the x-axis, the z-axis, or the y-axis to provide a spatial reference is not intended to be limiting. Any suitable coordinate system may be used. It is further noted that example implementations may involve an objective lens 202 that travels in a non-vertical direction.

The sample coverslip 212 may include a sample well 214 as shown in FIG. 2, which may be positioned for the imaging of a sample that may be deposited therein according to the normal functions and operation of the microscope system. In the example system shown in FIG. 2, the sample coverslip 212 has a first surface 212a and a second surface 212b, which can be considered as the bottom surface of a sample well. The first surface 212a and/or the second surface 212b may be at least partially reflective and thereby provide a reflective surface to use during an autofocus procedure or to use for a test image with surface 212b of the sample at a focal plane of objective lens 202 (described in detail below). The reflective surface may also be provided on a cover slip, or on surfaces of a slide, or other planar material disposed in the optical path in proximity to the bottom surface of the sample well 214.

The objective lens 202 may be moved along the z-axis using a linearly actuating motor controlled by controller 220. The objective lens 202 is represented schematically in FIG. 2 as including the linearly actuating motor that moves the objective lens 202. The objective lens 202 includes selected optics configured to focus light from the light source 206 onto a sample S on sample coverslip 212 held by sample stage 216 whereby the microscope system 200 can take an image of sample S. During the autofocus procedure, the objective lens 202 is controlled to focus on the surface 212a or 212b. In some implementations, the motor that moves the objective lens 202 may be a stepper motor or a servomotor with a linear actuator.

The light along the optical path passing through the decentered aperture 230 travels through the second imaging lens 240 to optical detector 204 where a projected source is imaged on a detector plane. When defocused, the light beam on optical detector 204 is spread in size and translates its position on the optical detector 204, has a lower intensity, and/or a low contrast. When the objective lens 202 is in focus, an image is captured at a maximum intensity, at a smallest size, and its highest contrast. The process of focusing the objective lens 202 involves moving the objective lens 202 to find the best focus position on the z-axis. Each beam spot in each image captured at each objective lens 202 z-position, appears on a position in the image plane that is offset from the spot position on the previous images.

In example implementations, optical detector 204 in the autofocusing system 200 may be a linear array detector, a charge-coupled device, a position sensitive diode, a 2-D sensor array as the image capturing device, or any suitable device that may be controlled by controller 220 to capture images of a reference image as the objective lens 202 is controlled to move to a series of z-positions. The light source 206 in the autofocusing system 200 may be any suitable light emitting device, such as a laser, a light emitting diode (LED) or an LED array, an incandescent light, a fluorescent light source, infrared light or the like.

The controller 220 may be implemented using any computer-programmable system having a hardware interface connected to at least the optical detector 204 and the motor configured to move the objective lens 202. In some implementations, the controller 220 may also be a component of the microscope system 221 for which the objective lens is being autofocused. The autofocusing procedure may be a function stored as software in the data storage medium 223 to which the controller 220 has access.

As illustrated in FIG. 2, an objective lens 202 disposed below sample coverslip 212 images a sample S through the transparent coverslip. The sample S is disposed on/above sample coverslip 212. An image focal plane 202a for objective lens 202 is shown in FIG. 2 coincident with the top reference surface 212b, where the sample S resides. The sample coverslip 212 can be a consumable substrate (for example a transparent, plastic bottom on microtiter plates). The sample well 214 shown in FIG. 2 can be a single well as shown or can be representative of a plurality of wells, each having a bottom holding a sample to be imaged. The optical system also utilizes a calibration coverslip 250 which can be moved to take the place of sample coverslip 212.

In one embodiment, as illustrated in FIG. 2, light source 206 can be for example a laser or other light source such as light emitting diode or an incandescent light or a fluorescent light or tungsten halogen lamp used to project a narrow beam of light onto sample coverslip 212 (for producing a test image) and can be used to project a narrow beam of light onto calibration coverslip 250, when in place, (for producing a reference image). First imaging lens 208 directs the laser beam onto beam splitter 210 which directs the laser beam through objective lens 202 onto sample coverslip 212 where the laser light passes through surface 212a and then encounters surface 212b at the interior (well) side of sample coverslip 212. The laser light reaching surface 212b is reflected backwards through sample coverslip 212 and is imaged through the objective lens 202 and the second imaging lens 240 onto image plane 204a of optical detector 204. While light source 206 is shown in FIG. 2 as a single instrument, it can comprise multiple light emitting devices such as those described above being respectively controlled by controller 220 as needed for the particular imaging needed.

In one embodiment, a laser or a LED (or another source of narrow beam of light) could be used for exposure when capturing the test images and the reference images. In one embodiment, an incandescent light, a fluorescent light source, an infrared light or the like could be used for exposure when capturing sample images. In one embodiment, a narrow spectral wavelength light such as the laser or the LED could be used to excite fluorescence of the sample or could be used to capture light backscattered from a sample.

In one embodiment of the technology, aperture 230 selects which part of the image light that passes through the second imaging lens 240 to the image plane 204a of optical detector 204. In one embodiment of the technology, aperture 230 is disposed offset from the optical axis such that the light which is selected is light that has passed through a perimeter (or edge) region of objective lens 202 where spherical aberrations are the most severe. In one embodiment of the technology, autofocus is used in positioning either objective lens 202, or the first imaging lens 208, or the second imaging lens 240, or the sample coverslip 212, or the calibration coverslip 250 to produce the sharpest image for the reference image taken with calibration coverslip 250 in place or for the test image taken with sample coverslip 212 in place. The images obtained can be stored in storage 223 of controller 220 for subsequent processing carried out for example in processor 220a of controller 220 or any other processor in communication with controller 220. While the processor 220a and storage 223 are shown in FIG. 2 as modules of controller 220, either of processor 220a and storage 223 can be located remote from controller 220 and in communication with controller 220 as needed to exchange data and processing results and instructions therebetween. A correction collar 252 (as shown in FIG. 2) may be used to assist in improvement of the image quality.

When sample coverslip 212 is present in the optical path, in one embodiment, a focused laser beam (or other focused light) is reflected from the top surface of the sample substrate (e.g., from surface 212b of the sample coverslip 212) and is imaged onto image plane 204a to obtain a test image associated with the particular coverslip in use. In this embodiment, the image focal plane 202a for objective lens 202 is coincident with the top reference surface 212b of sample coverslip 212. The autofocused, reflected light from the surface of the sample substrate can be considered a single point of reflected light.

Similarly, when calibration coverslip 250 is present (instead of the sample coverslip 212) in the optical path, in one embodiment, a focused laser beam (or other focused light) is reflected from the top surface of calibration coverslip 250 (e.g., from the top of a uniformly thick glass slide, not necessarily holding a sample) and imaged onto the image plane 204a of optical detector 204 to obtain a reference image. In this embodiment, the image focal plane 202a for objective lens 202 is coincident with the top surface of calibration coverslip 250.

With the configuration illustrated in FIG. 2, both the test image taken with the sample coverslip 212 and the reference image taken with the calibration coverslip 250 can be obtained and stored in storage 223 of controller 220 for subsequent processing for example in processor 220a In one embodiment of the technology, test images taken with the light reflected back from sample coverslip 212 and images taken with the light reflected back through calibration coverslip 250 need not be made only with a single point of reflected light (as detailed above). Multiple image points could be directed to the sample coverslip 212 and/or the calibration coverslip 250. In other words, an array of image points could be used, which in effect would map the optical wavefront of the light propagating from the objective lens 202 toward the image plane of optical detector 204.

Furthermore, in one embodiment, the light reflecting from the top surfaces of the sample coverslip 212 and/or the calibration coverslip 250 could be a line image (or other well-defined shapes). Such a line image would (in effect) permit an assessment of the PSF across a lateral direction of the sample coverslip 212 and/or the calibration coverslip 250.

In one embodiment of the technology, as noted above, aperture 230 is set off-axis in order to assess better the impact of spherical aberration on focus for the sample coverslip 212 and/or the calibration coverslip 250, the impact of spherical aberration typically being greater for light passing closer to the edge of the pupil in a lens system. Nevertheless, in one embodiment of the technology, aperture 230 could be set on-axis or at other positions in optical paths 201, 203, 205, 207, and 209. In one embodiment of the technology, changing the off-axis position of aperture 230 permits interrogation of the optical wavefront of the light propagating from the objective lens 202 toward the image plane of optical detector 204. The aperture position, size, and shape may be specific to the particularities of the imaging system and PSF for deconvolution. The simplest aperture could be a single eccentric circle large enough to transmit a marginal ray bundle from the objective at a sufficient light level. However, a single asymmetrical aperture may have decreased a light level and may introduce a bias to the measured test or sample image, but could be compensated by adding an aperture on the opposite side of the light beam, a series of apertures, an annular ring, or the like when needed.

Theoretically, with no errors such as spherical aberration and/or defocus, the image of the light reflected back from the top surface of calibration coverslip 250 (when in place) should resemble an ideal point spread function. Any deviations from an ideal point spread function would be representative of errors in the optical system that would blur the optical image.

In one embodiment, processor 220a of controller 220 is configured to perform a deconvolution (for example a blind deconvolution) using the reference image taken from calibration coverslip 250 as an initial point spread function (PSFᵢ) in order to determine a calculated point spread function (PSF_{c}) needed to improve the image quality of the test image taken from light reflected from surface 212b of sample coverslip 212. In general, a blind deconvolution is a deconvolution technique that permits recovery of “original images” from a single or set of “blurred” images, which does not necessarily assume any prior knowledge of the image or a PSF. While regular linear and non-linear deconvolution techniques may utilize a known PSF in order to recover the original (non-blurred) images, for blind deconvolution, the PSF is estimated from an image, allowing the deconvolution to be performed. Here, in the present technology, as noted above, the reference image taken with the light reflected from calibration coverslip 250 is used as the initial (or estimated) point spread function (PSFᵢ) of the optical system including objective lens 202, sample coverslip 212, and the other optical components in the light path from the sample S to the image plane 204a of optical detector 204. In one embodiment, the deconvolution techniques of the present technology can be performed iteratively, whereby each iteration of the algorithm used for the deconvolution improves the estimation of a calculated PSF_{c} of the optical system. Alternatively, the deconvolution techniques used in the present technology may be performed non-iteratively, where one application of the algorithm used for the deconvolution successfully provides the good estimation of the calculated PSF_{c} of the optical system.

One deconvolution process is illustrated by the following equation (1);

g=h⊗f+n, (1)

where f is the original undistorted image, g is the distorted noisy image, h is the PSF of the system, ⊗ is the convolution operator, and n is any corrupting noise.

An interactive Lucy-Richardson restoration algorithm to recover a PSF is illustrated below in equation (2).

$${\hat{f}}_{h \div 1} = {\hat{f}}_{k} ( h * \frac{g}{h ⊗ {\hat{f}}_{k}} ) {=}^{Δ} ψ ( {\hat{f}}_{k} ) , \qquad ( 2 )$$

where \hat{f}ₖ is the estimate off (the original image) after k iterations, * is the correlation operator, and ψ_{·}( . . . ) is called the Richardson-Lucy (R-L) function. The image h⊗\hat{f}ₖ is referred to as the reblurred image. These and other suitable image processing techniques for deconvolution in the present technology are described in “Acceleration of iterative image restoration algorithms” by David S. C. Biggs and Mark Andrews in APPLIED OPTICS, vol. 36, no. 8, Mar. 10, 1997, pp. 1766-1755 (the entire contents of which are incorporated herein by reference) and are described in “DeconvolutionLab2: An open-source software for deconvolution microscopy” by Sage et al., in Methods vol. 115, Feb. 15, 2017, pp. 28-41 (the entire contents of which are incorporated herein by reference). Commercial image deconvolution software which can be used for the present technology are available from companies such as Media Cybernetics (1700 Rockville Pike, Suite 240 Rockville, Maryland USA 20852), Matlab® R2018a (version9.4.813654) (1 Apple Hill Drive, Natick, MA 01760-2098), and others.

Here, in one embodiment, processor 220a of controller 220 is configured to use, in equations (1) and (2), the reference image taken with the light projected and focused from light source 206 and reflected from the top surface of calibration coverslip 250 as h (the initial PSFᵢ of the optical system) and is configured to use the test image taken with the light projected and focused from light source 206 and reflected from the top surface of sample coverslip 212 as g (the distorted noisy image). Iterations using equation (2) would continue as needed to produce estimates (deconvolutions \hat{f}ₖ and \hat{f}ₖ₊₁) of the original image if not blurred by optical imperfections. During the iterations of this deconvolution process, the quality of the test image should improve until for example its spot shape, size, intensity, and\or location are optimal (and/or similar to the reference image) or until the differences in the deconvolutions \hat{f}ₖ and \hat{f}ₖ₊₁ are not substantial. Once an acceptable criterion for the convolution has been met, the parameters and computational settings for the deconvolution according to for example that of equation (2) are stored in storage 223, and processor 220a can now process every pixel of a sample image taken from sample S on sample coverslip 212 to produce an optimal image with the calculated PSF arrived at through the deconvolutions.

Accordingly, with the configuration illustrated in FIG. 2, there is provided an optical imaging system comprising (in this embodiment): an objective lens 202; a sample stage 216 configured to position a top surface of a) a sample coverslip 212 for holding a sample S or b) a calibration coverslip 250 at a focal plane 202a of objective lens 202; an optical detector 204 configured to capture at least a) a sample image of the sample on the sample coverslip 212, b) a reference image from light reflected back through the calibration coverslip 250 from the focal plane 202a of objective lens 202, and c) a test image from light reflected back through the sample coverslip 212 from the focal plane 202a of the objective lens 202; and a processor 220a programmed to retrieve reference image data from the reference image, retrieve test image data from the test image, deconvolve the test image data using the reference image data as an initial point spread function for the objective lens and the coverslip, through at least one deconvolution of the test image data, produce a deconvolved test image associated with a calculated point spread function for the objective lens and other optical components in use including the sample coverslip, and deconvolve the sample image using the calculated point spread function from the deconvolution of the test image data to thereby reduce (or eliminate) artifacts from the sample image.

In one embodiment of the technology, determination of the calculated PSF_{c} by blind deconvolution may be done during a run taking sample image data from each well. Similarly, determination of the calculated PSF_{c} may also be done after the images (the sample image data) are stored.

In one embodiment of the technology, test images are collected for a predetermined number of the wells or plates in use, and the settings for respective blind deconvolutions for each well is stored for later processing of sample images from each well. Determination of the calculated PSF_{c} for each well may use a reference image from each well as the initial PSF; and perform a deconvolution such as a blind deconvolution to arrive at calculated PSF_{c} of each well for subsequent deconvolution of the sample image data.

Accordingly, in one embodiment of the technology, under control of controller 220, optical detector 204 captures (at different lateral positions) plural sample images from the sample coverslip. Under control of controller 220, optical detector 204 captures (at the different lateral positions) plural calibrated reference images from the calibration coverslip. Under control of controller 220, optical detector 204 captures (at the different lateral positions) plural test images from light reflected back through the sample coverslip from the focal plane of the objective lens. Processor 220a produces respective deconvolved test images associated with respective calculated point spread functions for each lateral position, and then deconvolves the plural sample images using the respective calculated point spread functions for each lateral position to thereby reduce or remove artifacts from the plural sample images.

In one embodiment of the technology, processor 220a may determine that the calculated PSF_{c}, for a given number of wells, indicates that the variance is in the calculated PSF_{c} from well to well does not warrant performing a blind deconvolution of the test image for each and every well. Instead, a single estimated point spread function (PSF_{c}) for a multi-well sample holder can be used as the calculated PSF_{c} for processing sample image data for each well. Accordingly, in one embodiment of the technology, it may not be necessary to strictly use the iterative analysis described above in reference to equations (1) and (2) for each well being imaged. Furthermore, since the deconvolution technique of the present technology can be applied to each pixel in the sample image, the processed images can be presented to depict the intensity in the X-Z plane.

In one embodiment of the technology, under control of controller 220, optical detector 204 captures (from different sample coverslips) plural sample images. Under control of controller 220, optical detector 204 captures (from plural calibration coverslips) plural calibrated reference images. Under control of controller 220, optical detector 204 captures (from the different sample coverslips) plural test images from light reflected back through the different sample coverslips. Processor 220a produces respective deconvolved test images associated with respective calculated point spread functions for each sample coverslip, and then deconvolves the plural sample image using the respective calculated point spread functions for each coverslip to thereby reduce or remove artifacts from the plural sample images.

Moreover, while the deconvolutions discussed above are suitable for the present technology, other image processing techniques can also be used in the present technology. In one embodiment, processor 220a is configured to perform a deconvolution using a stored point spread functions (PSFₛ) associated with a particular set of sample coverslips where the PSFₛ for that particular set of sample coverslips (and the optics in use) has been already determined. In another embodiment, individual PSFₛ for each sample well set (and the optics in use) may have been already determined permitting processor 220a to perform a deconvolution using the stored PSFₛ for each well (and the optics in use). With these stored PSFₛ, linear and non-linear deconvolution techniques may then be able to recover original image(s) from the sample image data without the necessity of blind deconvolution iterations.

Regardless of the deconvolution technique utilized, in one embodiment, processor 220a is configured to calculate a quality metric indicative of the deconvolved image enhancement achieved after the deconvolution. The quality metric can be a measure of the full width half maximum (FWHM) improvement in resolution of a pixel in the recovered image. The quality metric can be a measure of a signal to noise ratio improvement of a pixel in the recovered image. The quality metric can be a measure of a signal strength improvement of a pixel in the recovered image. In one embodiment, the processor is programmed to determine for the calculated point spread function an optimized point spread function for improving image quality of the sample image by repeated deconvolutions of the test image and repeated comparisons of a) deconvolved images of the test image to b) the calibrated reference image until improvements in the deconvoluted images are incremental improvements.

In one embodiment of the technology, one or multiple metrics could be used to generate a single merit value associated with the deconvoluted images. Each of the metrics would have a criterion set for acceptable feature size, shape, position, intensity gradient, peak intensity value, or cross correlation.

In one embodiment of the technology, the reflected light from calibration coverslip 250 is utilized to obtain an initial point spread function PSFᵢ because the light projected and focused from light source 206 and reflected from the top surface of calibration coverslip 250 can be imaged as a single spot image representing a reference image. The PSFᵢ can be applied to the reflected light focused at top surface 212b of sample surface coverslip 212 for the test image, with a deconvolution of the test image then compared to the reference image in multiple ways such as those noted above, with in one embodiment each metric being assigned a weight to penalize diverging metrics.

In other words, a quality score of a merit function can be a weighted sum of various metrics such as spot size, spot morphology, spot intensity, spot location, spot gradient, and cross correlation for comparing the reference image taken from calibration coverslip 250 to a deconvolved test image, with the better quality score then associated with an optimized, calculated PSF_{c} to be used for deconvolving a sample image. Consecutive deconvolutions can be used create a final calculated PSF_{c} that is ideally within a preset percentage difference from the calibrated reference image or within a preset percentage difference change in the merit function.

In one embodiment, processor 220a is programmed to determine an optimized point spread function based on criterion of at least one of spot size, spot shape, spot intensity, and spot location obtained being only incrementally improved (within a 30% change in one or more of the criteria noted above, within 20%, within 10%, or preferably within 5%, or more preferably within 1%) after a consecutive deconvolution of the test image. In another embodiment, processor 220a is programmed to determine an optimized point spread function based on criterion of the quality score of the merit function after a subsequent deconvolution being a change in the quality score of less than 30%, less than 20%, less than 10%, or preferably less than 5%, or more preferably less than 1%.

In one embodiment, processor 220a is programmed to determine an optimized point spread function for improving image quality of the sample image by repeated blind deconvolutions of the test image and repeated comparisons of a) deconvolved images of the test image to b) the calibrated reference image until improvements in consecutive deconvoluted images are incremental improvements (within a 30% change in one or more of the criterion noted above, or within 20%, or within 10%, or preferably within 5%, and more preferably within 1%).

In one embodiment of the technology, once an acceptable PSF (hereinafter PSF₀) has been determined using the reference image and the test image taken for light reflected from respective top surfaces of the calibration coverslip 250 and the sample coverslip 212, the objective lens 202 can be adjusted to focus at a region above the top surface of the coverslip, for example a distance z₁ above the coverslip. A sample image taken at z₁ can then be processed for example using the Lucy-Richardson method described above (or other deconvolution techniques) to deconvolve the sample image at z₁ (through perhaps iterative blind convolutions) until an acceptable quality metric is obtained. At that point, processor 220a can store a new PSF associated with z₁ (hereinafter PSF₁). Thereafter, the objective lens 202 can be adjusted to focus at a distance z₂ farther above the coverslip than z₁. Once again, a sample image taken at z₂ can then be processed for example using the Lucy-Richardson method described above (or other deconvolution techniques) to deconvolve the image at z₂ (through perhaps iterative blind convolutions) until an acceptable quality metric is obtained based for example on the criterion noted above, and processor 220a can store the subsequently obtained PSF associated with z₂ (hereinafter PSF₂). In this way, imaging through a depth of a well holding the sample to be measured can be made with recovery of image quality at each depth.

In another embodiment, processor 220a has available for image processing a set of selectable point spread functions PSFₛ associated with different levels of spherical aberrations. Processor 220a can then select one or more of the selectable point spread functions PSFₛ from the set, and use the selected ones to deconvolve the image. In one embodiment, the above noted quality score can be used to decide which of the selectable point spread functions PSFₛ produced the better deconvolved images, and thus select one PSF as the one to use for deconvolution of the sample image at a particular level or height in sample well 214. In one embodiment, the processor 220a makes the selection from the set of selectable point spread function based on a level of spherical aberration expected from known perturbations. For example, the set of point spread functions PSFₛ may have point spread functions differing from each other according to an increment in spherical aberration (for example by 0.2 waves of spherical aberration). In one embodiment, the above noted quality score could be used to decide which of the selectable point spread functions PSFₛ produced the better deconvolved image, thus considered an optimized PSF.

In one embodiment, a model (or a database in the processor) associates each lateral image taken across sample well 214 with a selectable PSFₛ, based for example on stored point spread functions associated with known or expected lateral variations in the thickness of the sample coverslip 212 being used.

In general, most sample coverslips will show an increased spherical aberration with depth, although there may be some sample coverslips where the sample and the sample media are not at significantly different indices of refraction, and therefore the spherical aberrations may not be as prominent. Regardless, in one embodiment, since the amount of spherical aberration may increase with defocus into the sample, a model can be used to predict a number of waves of spherical aberration for a given defocus from an ideal focal position if there were no defocus and no spherical aberrations. In one embodiment, above the sample bottom, the model (or a database in processor 220b) would associate different selectable point spread functions with for example a known depth within sample well 214 or a known height z₁ above the top side 212b of sample coverslip 212, and the expected spherical aberration at these positions. A processor such as processor 220a would select one of the selectable point spread functions based on a measured or expected spherical aberration.

In an example, the selectable point spread functions available to the processor 220a for deconvolution are stored in a database during the initial manufacturing process. During this process the point spread functions are calculated with reference to the manufacturer installed system components including the optical lens, depths across each sample well 214, and/or known or expected lateral variations in the thickness of the sample coverslip 212 which may produce spherical aberration or defocus in the system. The selectable point spread functions are available to enable rapid deconvolution of images when utilizing known system components.

In one embodiment of the technology, if the object is at a height z₂, then the imaging processing could first ensure that the spherical aberration model is correct at that height z₂, before correcting for image blurring or for aberrations which are blurring the image of the object via deconvolution. In other words, while defocus could be determined at the height z₂, in one embodiment, the processor would use multiple z planes around height z₂ and pick a particular height from the multiple planes that has high (or otherwise acceptable) contrast (for example an acceptable signal to noise ratio of greater than 2 or an acceptable signal to background ratio of greater than 2 or a slope of signal consistently rising above the noise) and the apply the PSFs to that image. Accordingly, in one embodiment, the processor would evaluate, for different heights above the sample coverslip, appropriate levels for convolutions with the expected spherical aberrations at those heights, and then for those depths, where the acceptable contrast is found, enhance further the image quality by improving focus digitally or mechanically such as by use of the correction collar 252. This embodiment would be particularly useful in cases where a reference image has determined a PSF associated with optical system errors due for example to spherical aberrations or defocus or other imaging artifacts, and the sample S to be imaged is not simply on the top surface 212b of the sample coverslip but instead is at a depth for example of 100 microns above the sample coverslip 212. In that case, as the objective lens 202 or substrate stage 216 is moved to image the sample S at the 100 micron position, between the coverslip and the sample S, there would be no element present to reflect light back to the optical detector until the sample starts to become in focus. At that point, the processor would select PSFₛ in storage 223 (or otherwise accessible to the processor 220a) associated for example with heights of 96 microns, 98 microns, 100 microns, 102 microns, and 104 microns, and perform deconvolutions of the sample images taken at these positions to determine which of one of the selectable PSFs produces a deconvoluted image with the best contrast, quality score, or merit function. In one embodiment of the technology, as objects at different depths are imaged with an optimized PSF identified for each of the different depths, the model to predict spherical aberration with depth can be built up and improved.

### EXAMPLES

In the examples below, the Lucy-Richardson method and blind deconvolution were used to deconvolve the images in the examples below using the procedures for deconvolution described above. In the examples given below, a precision coverslip from Thorlabs (Newton, New Jersey, US) was glued using Norland 61 optical adhesive (Cranbury, New Jersey US) onto a microscope slide to serve as a calibration coverslip. The precision coverslip from Thorlabs had a thickness tolerance of 5 μm and was positioned on the microscope side with the precision coverslip facing downward toward light source 206.

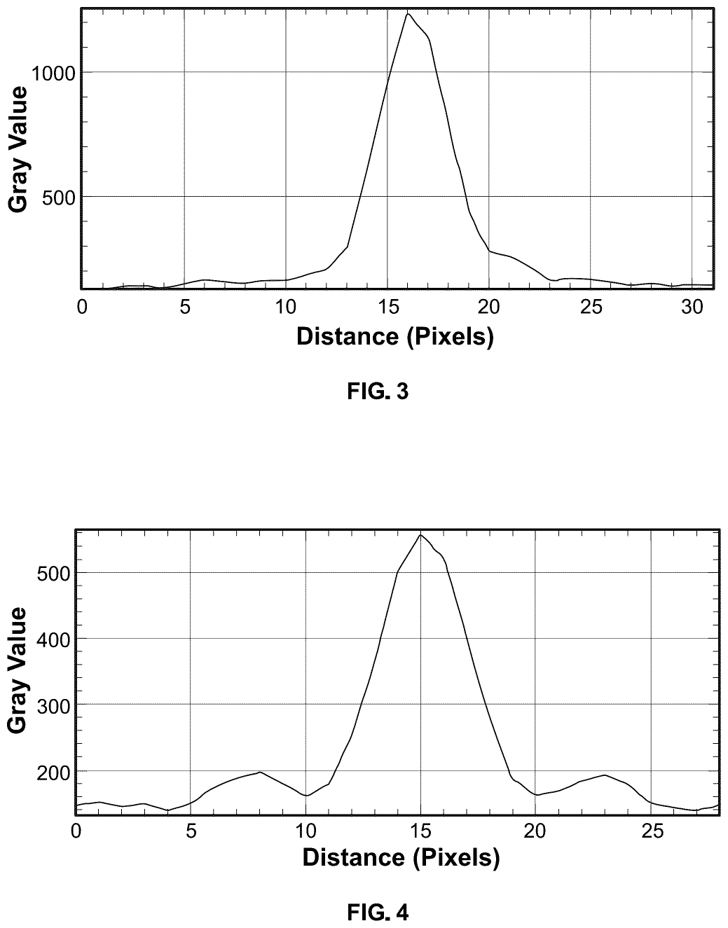

FIG. 3 depicts the intensity distribution of an optical image taken from an individual 0.5 μm bead at best focus and with an optimal correction collar setting. For later comparison purposes, the intensity distribution in FIG. 3 represents an “ideal” image intensity distribution for the 0.5 μm bead.

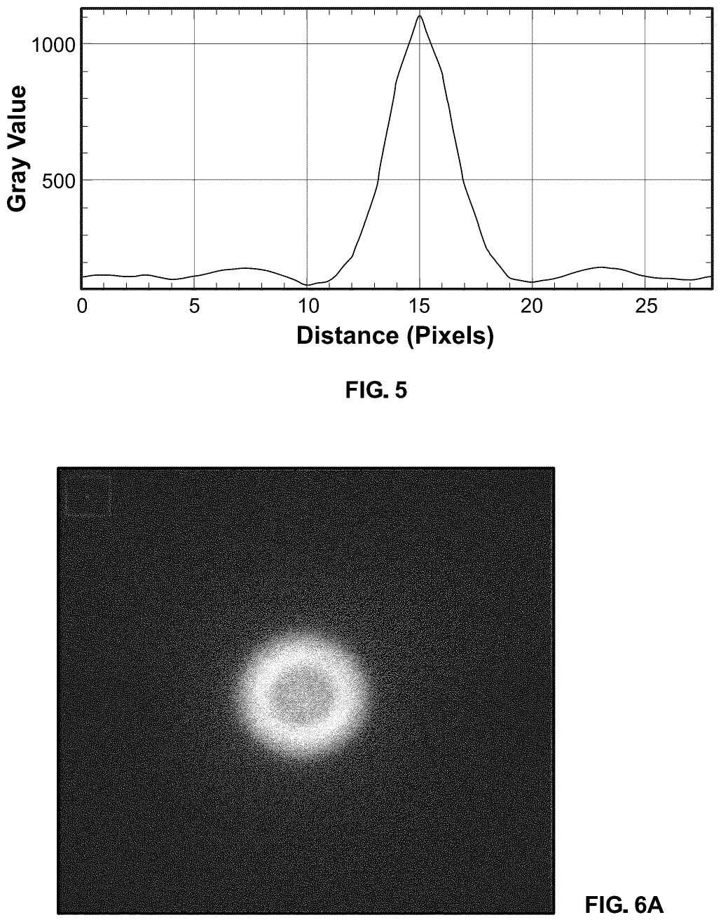

FIG. 4 depicts the intensity distribution of an optical image taken from an individual 0.5 μm bead at best focus but with a non-optimal correction collar setting. As expected, the image resolution and signal strength shown in FIG. 4 is degraded in comparison to the ideal image intensity distribution depicted in FIG. 3.

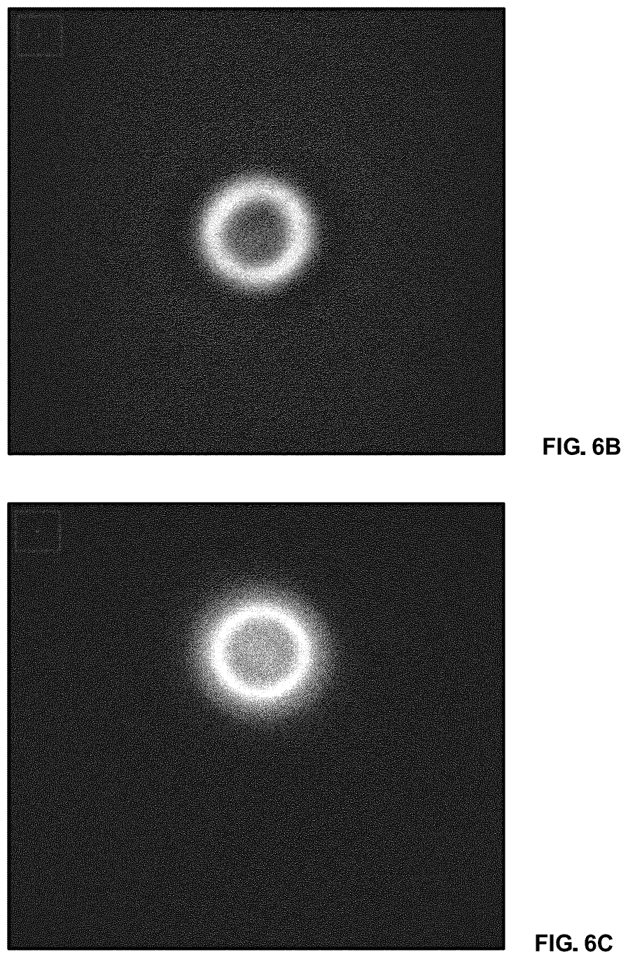

FIG. 5 depicts the intensity distribution of a mathematically processed image using the deconvolution techniques of the present technology to process the non-optimal optical image of FIG. 4. As apparent, both the image resolution and signal strength for the mathematically processed image improve with the mathematical deconvolution of the present technology.

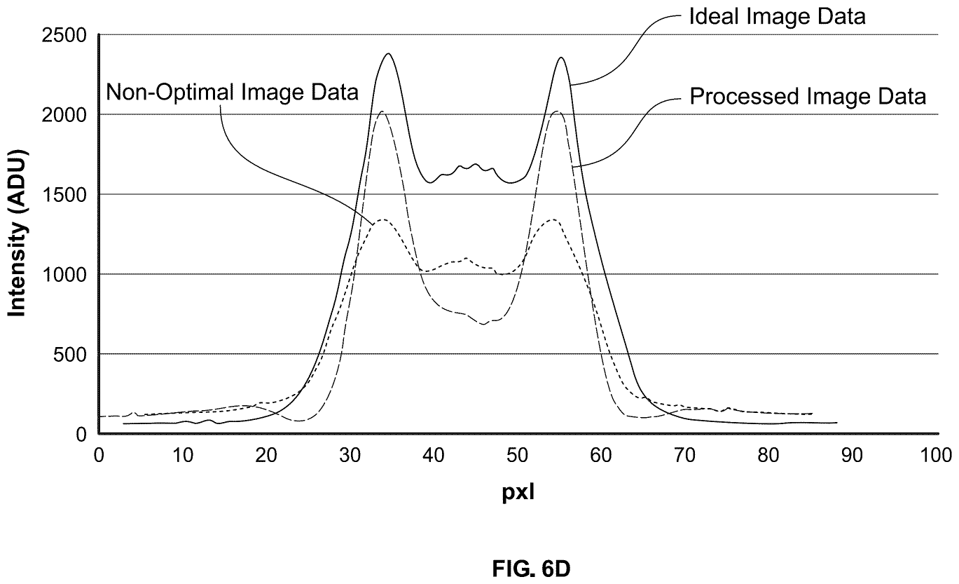

FIG. 6A depicts another optical image taken from a 4.0 μm bead at best focus but under non-optimal imaging conditions having a non-optimal correction collar setting. FIG. 6B depicts the image data in FIG. 6A processed using the present technology deconvolution process. FIG. 6C depicts an optical image taken at best focus from the same 4.0 μm bead of FIG. 6A, but taken here under optimal imaging conditions. The closer the processed image data of FIG. 6B matches the optical image data of FIG. 6C, the better the present technology deconvolution is in recovery from a non-optimal image of what the actual image of the object should be.

FIG. 6D is a graphical comparison of the intensity profiles of FIGS. 6A, 6B, and 6C. This comparison shows that the present technology deconvolution process permits images taken under non-optimal conditions to “recover” many of the attributes seen in the image taken under optimal imaging conditions such as peak intensity and FWHM, thereby permitting useful image data to be obtained without the time and effort of a user making actual optical adjustments such as by a correction collar or by other means. Viewed differently, FIGS. 6A, 6B, 6C, and 6D show the efficacy of the present technology to recover useful image data from images otherwise blurred because optical system errors due for example to spherical aberrations or defocus or other imaging artifacts.

### Computer Control

It will be understood that the controller 220 schematically illustrated in FIG. 2 is but representative of a variety of computing devices including for example one or more types of user devices, such as user input devices (e.g., keypad, touch screen, mouse, and the like), user output devices (e.g., display screen, printer, visual indicators or alerts, audible indicators or alerts, and the like), and computational devices. Controller 220 (or processor 220a) may have a graphical user interface (GUI) controlled by software for display by an output device, and one or more devices for loading media readable (e.g., logic instructions embodied in software, data, and the like). Controller 220 (or processor 220a) includes an operating system (e.g., Microsoft Windows® software) for controlling and managing various functions thereof, and therefore comprises a processor.

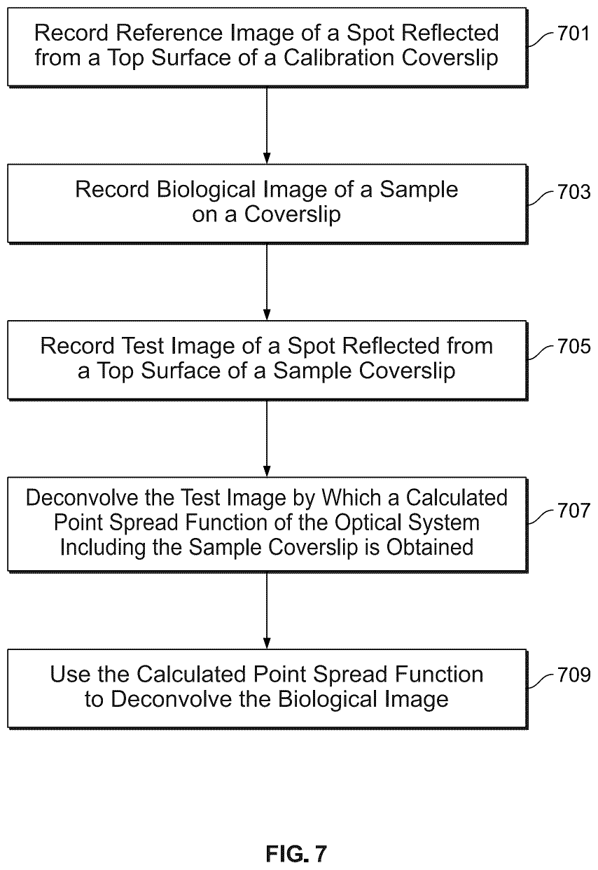

FIG. 7 is a flowchart detailing a computerized method of the present technology for imaging a sample which can be implemented in controller 220 or with processor 220a. While forsake of labelling the steps a numeric set of numbers follows, the technology is not limited to the steps occurring necessarily in the numeric order given.

At step 701, a reference image of a spot reflected from a top surface of a calibration coverslip (or other standard reference slide) is recorded (for subsequent image processing in processor 220). In a preferred option, aperture 230 is off-set from the optical axis and samples (selects) only a part of the wave front of the spot reflected and passing through a perimeter region of objective lens 202 where spherical aberration changes by the 4th power.

At step 703, a biological image of a sample on a sample coverslip is recorded (for subsequent image processing in processor 220a).

At step 705, a test image of a spot reflected from a top surface of a sample coverslip is recorded (for subsequent image processing in processor 220a). (Steps 703 and 705 may occur in reverse order.)

At step 707, the test image is deconvolved (by processor 220a) by which a calculated point spread function of the optical imaging system including the sample coverslip is obtained. In a preferred option, the deconvolution imaging process (described above including, but not limited to, the blind deconvolutions and the Lucy-Richardson algorithms) is used with the test image serving as a first approximation of the optical system's point spread function to recover a point spread function. In a preferred option, with the test image taken with an off-set aperture, the recovered PSF will reduce spherical aberrations.

At step 709, the calculated point spread function is used (e.g., by processor 220a) to deconvolve the biological image. If there is little variation in the sample coverslip thickness, then the calculated PSF does not need to be re-computed as often when imaging from well to well. In another embodiment of the technology, based on the amount of defocus seen in the test image, a test image library for defocus can be used a) to set a focus position for the objective lens and b) to determine an appropriate test image to be used in obtaining an appropriate calculated PSF of the optical components in use.

As noted above, while in one embodiment the present technology is directed to an inverted microscope configuration such as the system shown in FIG. 2, the present technology can be applied to non-inverted microscope configurations. In that case, the laser beam or other light reflected from a calibration coverslip would be reflected from a focal plane on a side of the calibration coverslip (or other reference plate) facing objective lens 202 (i.e, objective lens 202 and the imaging optics would be above sample coverslip 212 supporting a sample to be imaged. The same steps would then follow with test image(s) and the reference image(s) being taken from a laser beam or other light reflected at the focal plane on a side of the calibration coverslip or calibration coverslip facing objective lens 202. The reference image would be used as the initial PSF for deconvolution of the test image from which a calculated PSF for the optical system including objective lens 202 and the imaging optics would be derived. A sample image taken from the sample coverslip supporting the sample would then be deconvolved using the optimal PSF.

In one embodiment of the technology in the non-inverted configuration, the reflection used for the reference and test images would be taken from an image focal plane located on an inside surface of a coverslip closer to the sample. The sample position of interest may progress through a thick sample or (in the case described below with an immersed objective) into a depth of the well holding a sample.

In one embodiment of the technology in the non-inverted configuration, where the objective is immersed into sample media, the mismatch of the index of refraction for the sample and design of the objective will introduce spherical aberrations. In this case, a similar process as descried above for the inverted configuration imaging at different depths into the sample well can be applied. That is a sample image taken at z₁ (closest to the bottom of the coverslip) can then be processed for example using the Lucy-Richardson method described above (or other deconvolution techniques) to deconvolve the sample image at z₁ (through perhaps iterative blind convolutions) until an acceptable quality metric is obtained. At that point, processor 220a can store a new PSF associated with z₁ (hereinafter PSF₁). Thereafter, the objective lens 202 can be adjusted to focus at a distance z₂ farther below the coverslip than z₁. Once again, a sample image taken at z₂ can then be processed for example using the Lucy-Richardson method described above (or other deconvolution techniques) to deconvolve the image at z₂ (through perhaps iterative blind convolutions) until an acceptable quality metric is obtained based for example on the criterion noted above, and processor 220a can store the subsequently obtained PSF associated with z₂ (hereinafter PSF₂). In this way, imaging in the non-inverted configuration deeper into a depth of the well holding the sample to be measured can be made with recovery of image quality at each depth.

Similarly to that described above, in one embodiment with the non-inverted configuration, since the amount of spherical aberration may increase with depth into the sample or viewed differently may increase with height above the top surface 212b of sample coverslip 212, a model can be used to predict a number of waves of spherical aberration for a given depth in a sample well 214 or height z₁ above the top surface 212b of sample coverslip 212. In one embodiment, a model (or a database accessible by processor 220a) could associate different selectable point spread functions with expected spherical aberrations. A processor such as processor 220a would select at least one of the selectable point spread functions (associated with a different displacements about the height z₁, perform deconvolutions of the sample images at the different displacements, and select a particular PSF based for example (as noted above) on the observed contrast obtained following the sample image deconvolutions.

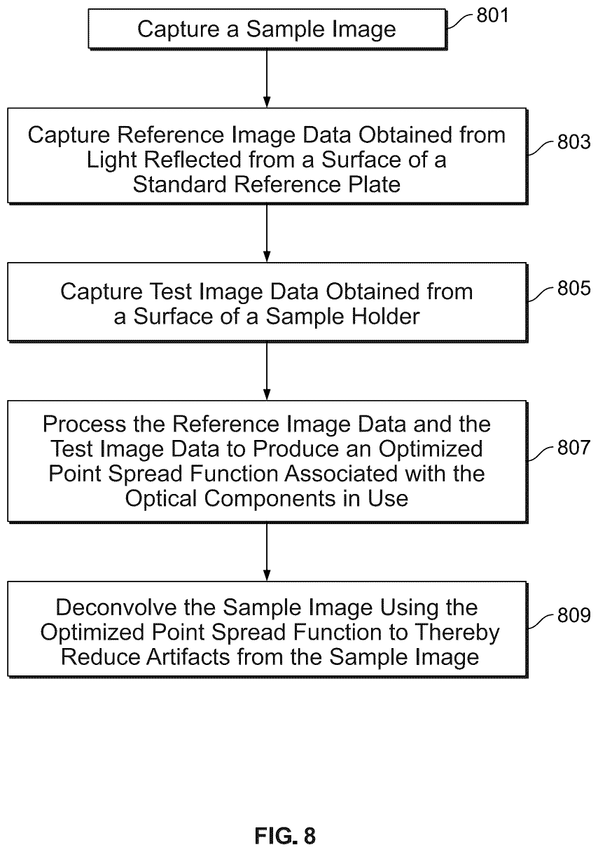

Regardless of the inverted or non-inverted microscope configuration, FIG. 8 is a flowchart detailing another computerized method of the present technology for imaging a sample which can be implemented in controller 220 or with processor 220a.

At step 801, a sample image (for example of a sample on the top surface of a sample holder) is captured. At step 803, reference image data obtained from a focused laser beam or other light reflected from a surface (e.g., the top surface) of a standard reference plate such as a calibration coverslip is captured. At step 805, test image data obtained from a focused laser beam or other light reflected from a surface (e.g., a top surface) of a sample holder such as a sample coverslip is captured. At step 807, the reference image data and the test image data are processed to produce an optimized point spread function associated with the optical components in use. At step 809, the sample image is deconvolved using the optimized point spread function to thereby reduce or remove artifacts from the sample image.

It will be understood that one or more of the processes, sub-processes, and process steps described herein may be performed by hardware, firmware, software, or a combination of two or more of the foregoing, on one or more electronic or digitally-controlled devices for example. The software may reside in a software memory (not shown) in a suitable electronic processing component or system such as, for example, controller 220 and/or processor 220a schematically depicted in FIG. 2. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), or application specific integrated circuits (ASICs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by processor 220a and/or controller 220, direct the electronic system to carry out the instructions and may read from storage 223 data in image files containing measured or processed data. In one embodiment, the executable instructions permit for example controller 220 or processor 220a to store in memory 223 (or in an internal memory of processor 220a) measured or processed image data such as for example reference image data from a reference image and/or test image data from a test image (e.g. from an initial test image). Further, the executable instructions can permit controller 220 or processor 220a to a) deconvolve the test image data using the reference image data as an initial point spread function for the objective lens and the coverslip, b) through at least one deconvolution of the test image data, produce a calculated point spread function for the objective lens and other optical components in use including the sample coverslip, and c) deconvolve the sample image using the calculated point spread function from the deconvolution of the test image data to thereby reduce or remove artifacts from the sample image.

In one embodiment, the executable instructions permit controller 220 to control at least one of a) a vertical displacement of the objective lens relative to the coverslip, b) a lateral displacement of the objective lens relative to the coverslip, c) an exposure duration of the optical detector, d) an intensity of the light source illuminating the sample, e) insertion of an optical filter into an optical path, f) positioning of an off-axis aperture in the optical path, g) autofocus adjustment, and h) other optical detector or camera settings.

In one embodiment, the executable instructions permit controller 220 to control at least one of a position of the objective lens 202 or a distance of the sample coverslip 212 from the objective lens 202 in order to focus the light from the light source at the focal plane of the objective lens. In one embodiment, under control of controller 220, optical detector 204 can capture at different lateral positions plural sample images from the sample coverslip, can capture at the different lateral positions plural calibrated reference images from the calibration coverslip, and can capture at the different lateral positions plural test images from light reflected back through the sample coverslip from the focal plane of the objective lens, and processor 220a can produce respective deconvolved test images associated with respective calculated point spread functions for each lateral position, and can deconvolve the plural sample images using the respective calculated point spread functions for each lateral position to thereby reduce or remove artifacts from the plural sample images. In another embodiment, under control of controller 220, optical detector 204 can capture from different sample coverslips plural sample images, can capture plural calibrated reference images from plural calibration coverslips respectively associated with the different sample coverslips, and can capture from the different sample coverslips plural test images from light reflected back through the different sample coverslips, and processor 220a can produce respective deconvolved test images associated with respective calculated point spread functions for each sample coverslip, and can deconvolve the plural sample image using the respective calculated point spread functions for each coverslip to thereby reduce or remove artifacts from the plural sample images.

The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic), a read-only memory (electronic); an erasable programmable read only memory such as, for example, flash memory (electronic); a compact disc memory such as, for example, CD-ROM, CD-R, CD-RW (optical); and digital versatile disc memory, i.e, DVD (optical). The non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory such as storage 223 or an internal memory of processor 220a.

It will also be understood that the term “in signal communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will also be understood that receiving and transmitting of data as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

### Exemplary Statements of the Technology

The following numbered statements of the technology set forth a number of inventive aspects of the present technology:

Statement 1. An optical imaging system comprising, a sample stage configured to hold a sample to be imaged on a top surface of a sample coverslip; an objective lens disposed underneath the sample stage and configured to image the sample on the top surface of the sample coverslip; an optical detector configured to capture at least a sample image of the sample on the sample coverslip; and a processor programmed to retrieve reference image data from a reference image captured from a calibration coverslip, retrieve test image data from a test image captured from light reflected from a top surface of the sample coverslip at a focal plane of the objective lens, process the reference image data and the test image data to produce (via a deconvolution of the test image data) a calculated point spread function associated with the objective lens and other optical components in use, and deconvolve the sample image using the calculated point spread function to thereby reduce or remove artifacts from the sample image.

Statement 2. The system of statement 1, wherein the processor is programmed to perform a blind deconvolution of the test image data to determine the calculated point spread function.

Statement 3. The system of statements 1 or 2, wherein the processor is programmed to determine for the calculated point spread function an optimized point spread function for improving image quality of the sample image by repeated deconvolutions of the test image and repeated comparisons of a) deconvolved images of the test image to b) the calibrated reference image until improvements in the deconvoluted images are incremental improvements.

Statement 4. The system of any of the statements above, wherein the processor is programmed to determine an optimized point spread function based on criterion of at least one of spot size, spot shape, spot intensity, and spot location obtained being only incrementally improved after a consecutive deconvolution of the test image.

Statement 5. The system of any of the statements above, wherein the processor is programmed to determine an optimized point spread function for improving image quality of the sample image by repeated blind deconvolutions of the test image and repeated comparisons of a) deconvolved images of the test image to b) the calibrated reference image until improvements in consecutive deconvoluted images are incremental improvements.

Statement 6. The system of any of the statements above, further comprising a light source providing light to be focused at the focal plane.

Statement 7. The system of any of the statements above, further comprising a controller configured to control at least one of a) a vertical displacement of the objective lens relative to the coverslip, b) a lateral displacement of the objective lens relative to the coverslip, c) an exposure duration of the optical detector, d) an intensity of the light source illuminating the sample, e) insertion of an optical filter (e.g. a spectral filter and/or a spatial filter) into an optical path, f) positioning of an off-axis aperture in the optical path, g) autofocus adjustment, and h) other optical detector or camera settings.

Statement 8. The system of any of the statements above, wherein the controller controls at least one of a position of the objective lens and a position of the sample stage in order to focus the light from the light source at the focal plane of the objective lens.

Statement 9. The system of claim 8, wherein, under control of the controller, the optical detector captures at different lateral positions plural sample images from the sample coverslip, under control of the controller, the optical detector captures at the different lateral positions plural calibrated reference images from the calibration coverslip, under control of the controller, the optical detector captures at the different lateral positions plural test images from light reflected back through the sample coverslip from the focal plane of the objective lens, the processor produces respective deconvolved test images associated with respective calculated point spread functions for each lateral position, and the processor deconvolves the plural sample images using the respective calculated point spread functions for each lateral position to thereby reduce or remove artifacts from the plural sample images.

Statement 10. The system of statement 8, wherein under control of the controller, the optical detector captures from different sample coverslips plural sample images, under control of the controller, the optical detector captures plural calibrated reference images from plural calibration coverslips respectively associated with the different sample coverslips, under control of the controller, the optical detector captures from the different sample coverslips plural test images from light reflected back through the different sample coverslips, the processor produces respective deconvolved test images associated with respective calculated point spread functions for each sample coverslip, and the processor deconvolves the plural sample image using the respective calculated point spread functions for each coverslip to thereby reduce or remove artifacts from the plural sample images.

Statement 11. The system of any of the statements above, further comprising a correction collar compensating for optical aberrations due to the sample coverslip.

Statement 12. The system of any of the statements above, wherein the processor stores in memory respective optimized point spread functions of plural coverslips having respective standard thicknesses.

Statement 13. The system of any of the statements above, wherein the processor stores in memory respective optimized point spread functions associated with different kinds of coverslips having different optical thicknesses.

Statement 14. The system of any of the statements above, wherein the processor is further configured to: retrieve for the sample image an image taken from a position z₁ displaced from the sample coverslip, ascertain a spherical aberration associated with the position z₁, retrieve a set of selectable point spread functions each having different spherical aberrations associated with different heights displaced from the position z₁, select from the set of selectable point spread functions a starting point spread function associated with the spherical aberration ascertained, and deconvolve the sample image at position z₁ using the starting point spread function,

Statement 15. The system of any of the statements above, wherein the processor is further configured to: retrieve a first sample image taken at a first position z₁ displaced from the sample coverslip, determine a first calculated point spread function to reduce artifacts from the first sample image at first position z₁, retrieve a second image taken at a second position z₂ farther removed from the sample coverslip than the first position z₁, and using the first calculated point spread function as a starting point spread function in a deconvolution, determine a second calculated point spread function to reduce artifacts from the second sample image taken at the second position z₂.

Statement 16. The system of any of the statements above, further comprising an off-axis aperture in an optical path to the optical detector.

Statement 17. The system of any of the statements above, further comprising a beam splitter disposed underneath the objective lens to direct light from a light source through the objective lens and onto the sample coverslip or the calibration coverslip.

Statement 18. An optical imaging system comprising: an objective lens; a sample stage configured to position a top surface of a) a sample coverslip for holding a sample or b) a calibration coverslip at a focal plane of the objective lens; an optical detector configured to capture at least a) a sample image of the sample on the sample coverslip, b) a reference image from light reflected back through the calibration coverslip from the focal plane of the objective lens, and c) al test image (e.g. an initial test image) from light reflected back through the sample coverslip from the focal plane of the objective lens; and a processor programmed to retrieve reference image data from the reference image, retrieve test image data from the test image, deconvolve the test image data using the reference image data as an initial point spread function for the objective lens and the coverslip, through at least one deconvolution of the test image data, produce a deconvolved test image associated with a calculated point spread function for the objective lens and other optical components in use including the sample coverslip, and deconvolve the sample image using the calculated point spread function from the deconvolution of the test image data to thereby reduce or remove artifacts from the sample image.

Statement 19. The system of statement 18, wherein the processor utilizes the reference image data as the initial point spread function for producing an optimized point spread function associated with the sample coverslip.

Statement 20. A computerized method for imaging a sample, comprising, capturing a sample image of the sample using an objective lens disposed underneath a sample coverslip holding the sample; obtaining reference image data obtained from a calibration coverslip, capturing test image data obtained from light reflected from a top surface of the sample coverslip at a focal plane of the objective lens; processing the reference image data and the test image data to produce (via a deconvolution of the test image data) a calculated point spread function associated with the objective lens and other optical components in use, and deconvolving the sample image using the calculated point spread function to thereby reduce or remove artifacts from the sample image. This method can be performed with any of the components of the optical imaging systems set forth in statements 1-19.

Statement 21. A computer readable medium storing instructions that, when executed by a computer, cause it to perform a method steps of: capturing a sample image of the sample using an objective lens disposed underneath a sample coverslip holding the sample; obtaining reference image data obtained from a calibration coverslip, capturing test image data obtained from light reflected from a top surface of the sample coverslip at a focal plane of the objective lens; processing the reference image data and the test image data to produce (via a deconvolution of the test image data) a calculated point spread function associated with the objective lens and other optical components in use; and deconvolving the sample image using the calculated point spread function to thereby reduce or remove artifacts from the sample image. This computer readable medium can be stored for example in controller 220 and/or processor 220a or other similar computing devices in communication with controller 220 and/or processor 220a.

Statement 22. A method for imaging a sample, comprising: capturing a sample image; capturing reference image data obtained from light reflected from a surface of a standard reference plate; capturing test image data obtained from light reflected from a surface of a sample holder: processing the reference image data and the test image data to produce an optimized (or calculated) point spread function associated with the optical components in use; and deconvolving the sample image using the optimized point spread function to thereby reduce or remove artifacts from the sample image. This method can be performed with any of the components of the optical imaging systems set forth in statements 1-19.

Statement 23. A computer readable medium storing instructions that, when executed by a computer, cause it to perform a method steps of: capturing a sample image; capturing reference image data obtained from light reflected from a surface of a standard reference plate, capturing test image data obtained from light reflected from a surface of a sample holder; processing the reference image data and the test image data to produce an optimized (or calculated) point spread function associated with the optical components in use; and deconvolving the sample image using the optimized point spread function to thereby reduce or remove artifacts from the sample image. This computer readable medium can be stored for example in controller 220 and/or processor 220a or other similar computing devices in communication with controller 220 and/or processor 220a.

Statement 24. An optical imaging system comprising: means for capturing a sample image of a sample; means for obtaining reference image data obtained from a calibration coverslip, means for capturing test image data obtained from light reflected from a top surface of the sample coverslip; means for processing the reference image data and the test image data to produce (via a deconvolution of the test image data) a calculated point spread function associated with the objective lens and other optical components in use; and means for deconvolving the sample image using the calculated point spread function to thereby reduce or remove artifacts from the sample image.

Statement 25. An optical imaging system comprising: means for capturing a sample image; means for capturing reference image data obtained from light reflected from a surface of a standard reference plate; means for capturing test image data obtained from light reflected from a surface of a sample holder, means for processing the reference image data and the test image data to produce an optimized (or calculated) point spread function associated with the optical components in use; and means for deconvolving the sample image using the optimized point spread function to thereby reduce or remove artifacts from the sample image.

Statement 26. An optical imaging system comprising an objective lens; a sample stage configured to position a top surface of a) a sample coverslip for holding a sample or b) a calibration coverslip at a focal plane of the objective lens; means for capturing at least a) a sample image of the sample on the sample coverslip, b) a reference image from light reflected back through the calibration coverslip from the focal plane of the objective lens, and c) a test image (e.g. an initial test image) from light reflected back through the sample coverslip from the focal plane of the objective lens; and means for deconvolving the sample image using a calculated point spread function obtained from at least one deconvolution of the test image using the reference image as an initial point spread function for the deconvolution.

Statement 27. An optical imaging system comprising: means for capturing a sample image of a sample: and means for deconvolving the sample image to thereby reduce or remove artifacts from the sample image, wherein the means for deconvolving retrieves for the sample image an image taken from a position z₁ displaced from a sample coverslip, ascertains a spherical aberration associated with the position z₁ retrieves a set of selectable point spread functions each having different spherical aberrations associated with different heights displaced from z₁, selects from the set of selectable point spread functions a starting point spread function associated with the spherical aberration ascertained, and deconvolves the sample image at position z₁ using the starting point spread function.

Statement 28. An optical imaging system comprising: means for capturing a sample image of a sample; and means for deconvolving the sample image to thereby reduce or remove artifacts from the sample image, wherein the means for deconvolving retrieves a first sample image taken at a first position z₁ displaced from a sample coverslip, determines a first calculated point spread function to reduce artifacts from the first sample image at z₁, retrieves a second image taken at a second image position z₂ farther removed from the sample coverslip than z₁, and using the first calculated point spread function as a starting point spread function in a deconvolution, determines a second calculated point spread function to reduce artifacts from the second sample image at z₂.

It will be understood that various aspects or details of the technology may be changed without departing from the scope of the technology. Furthermore, the foregoing description is for the purpose of illustration only, and not for the purpose of limitation—the technology being defined by the claims.

1. A well tray comprising:
a base comprising:
an upper surface;
a lower surface; and
at least one edge surface connecting the upper surface to the lower surface,
wherein the at least one edge surface defines a slot, and wherein the slot is in communication with a magnet receiver at least partially defined between the upper surface and the lower surface, wherein the magnet receiver is configured to slidably receive a removable magnet; and
a plurality of wells disposed on an upper surface of the base.

2. The well tray of claim 1, wherein the plurality of wells are arranged in a plurality of columns comprising a column width dimension and a plurality of rows comprising a row length dimension, and wherein the magnet receiver comprises a receiver width dimension substantially similar to the column width dimension and a receiver length dimension substantially similar to the row length dimension.

3. The well tray of claim 1, wherein the plurality of wells are arranged in a plurality of columns comprising a column width dimension and a plurality of rows comprising a row length dimension, and wherein the magnet receiver comprises a receiver width dimension greater than the column width dimension and a receiver length dimension greater than the row length dimension.

4. The well tray of claim 2, wherein the base comprises a base width dimension greater than the column width dimension and a base length dimension greater than the row length dimension.

5. The well tray of claim 1, wherein the magnet receiver comprises a plurality of magnet receivers, wherein the plurality of magnet receivers are oriented substantially parallel with at least one of a row of the plurality of wells and at least one column of the plurality of wells.

6. The well tray of claim 1, wherein the magnet receiver defines a reception axis along which the magnet is slidably received in the magnet receiver, and wherein the magnet receiver comprises an edge support for slidably supporting an edge of the magnet.

7. The well tray of claim 6, wherein the edge support comprises a height less than a height of the magnet receiver.

8. The well tray of claim 6, wherein the edge support comprises a low-friction material.

9. The well tray of claim 6, wherein the slot comprises a magnet throat for receiving the edge of the magnet during an insertion of the magnet.

10. The well tray of claim 9, wherein the magnet throat is tapered.

11. The well tray of claim 1, wherein the lower surface at least partially defines an access opening in communication with the magnet receiver.

12. A sample analyzer comprising:
a support platform for receiving a well tray, wherein the support platform comprises:
an upper surface;
a registration feature connected to the upper surface, wherein the registration feature is configured for receiving, in a predetermined orientation, the well tray;
at least one edge surface connected to the upper surface, wherein the at least one edge surface at least partially defines a slot for slidably receiving a removable magnet; and
a magnet receiver defined by the support platform and in communication with the slot.

13. The sample analyzer of claim 12, wherein the magnet receiver is configured to slidably receive the removable magnet.

14. The sample analyzer of claim 12, wherein the registration feature is disposed so as to align the registration feature with the magnet receiver.

15. The sample analyzer of claim 12, further comprising the removable magnet, wherein the removable magnet comprises a tab, wherein the tab is configured to project from the at least one edge surface when the removable magnet is disposed in the magnet receiver.

16. The sample analyzer of claim 12, wherein the support platform at least partially defines an access opening in communication with the magnet receiver.

17. The sample analyzer of claim 12, wherein the registration feature comprises the removable magnet.

18. The sample analyzer of claim 12, wherein the registration feature comprises a plurality of projections extending from the upper surface, wherein the plurality of projections define a registration area therebetween.

19. The sample analyzer of claim 18, wherein the magnet receiver comprises a receiver area.

20. The sample analyzer of claim 19, wherein the receiver area is greater than the registration area.
